(19) United States
(12) Patent Application Publication
(10) Pub. No.: US 2026/0285669 A1
(43) Pub. Date: Sep. 24, 2026

(54) PRECISION NOZZLE AND PROCESS FOR PRODUCING THE SAME

(71) Applicant: KYORITSU GOKIN CO., LTD., Hyogo (JP)

(72) Inventors: Shinya IKEDA, Hyogo (JP); Yasuharu FUKUICHI, Hyogo (JP)

(21) Appl. No.: 18/879,988

(22) PCT Filed: Apr. 26, 2023
(86) PCT No.: PCT/JP2023/016411

§ 371 Date: Dec. 30, 2024

(30) Foreign Application Priority Data
Oct. 24, 2022 (JP) 2022-169800
Apr. 18, 2023 (JP) 2023-067550

(51) Int. Cl. B67D 3/00; B22F 3/16; B22F 3/24; B22F 5/10; C22C 1/051; C22C 29/06; C22C 29/08

(52) U.S. Cl. CPC B67D 3/0058; B22F 3/162; B22F 3/24; B22F 5/10; C22C 1/051; C22C 29/067; C22C 29/08; B22F 2003/247; B22F 2301/15; B22F 2302/10; B22F 2998/10; B22F 2999/00

(57) ABSTRACT

A precision nozzle produced through a compacting step of compression-forming a raw powder using a transfer mold for forming a through hole to give a compact that has a blind hole with an opening corresponding to an inlet, a sintering step of sintering the compact to give a sintered compact that has the blind hole with the opening corresponding to the inlet, an electrical discharge machining step of subjecting the blind hole of the sintered compact to electrical discharge machining using an electrode, and a grinding step of grinding the electrical-discharge-machined sintered compact from a side opposite to the opening, which corresponds to the inlet, to form the outlet. The resulting precision nozzle includes a cemented carbide and has a through hole passing from an inlet to an outlet, and the through hole contains a tapered hole portion extending to increase in inner diameter from the outlet toward the inlet.

### TECHNICAL FIELD

The present invention relates to a precision nozzle having a minute hole diameter used in the field of electronic components or other fields, and a process for producing the precision nozzle.

### BACKGROUND ART

Downsizing of electronic devices due to recent technological innovation has promoted miniaturization or higher densification of semiconductor elements or integrated circuits in semiconductor devices in the field of electronic components mounted on the electronic devices including smartphones, tablet personal computers (PC), gaming consoles or devices, motherboards, and digital cameras. In a production process of such a semiconductor device, assembly of a micro component or mounting thereof on a substrate uses a nozzle. Known examples of the nozzle include a reflow nozzle, a suction nozzle, and a solder jetting nozzle, each of which is a precision nozzle having a minute discharge hole or suction hole. For example, the reflow nozzle includes a nozzle for feeding a molten solder (solder cream) on a substrate by melting of a solder ball having a diameter of about 40 μm with laser irradiation. Such a reflow nozzle has an outlet (or a discharge outlet) with a minute hole diameter as small as the diameter of the solder ball in order to allow the solder ball to temporarily stay near the outlet. In addition, the precision nozzle such as the reflow nozzle is to have a precisely shaped flow path (or flow passage or flow channel) for intended precise positioning. Thus, production of the precision nozzle such as the reflow nozzle uses a high-precision processing. In particular, the reflow nozzle is also intended to have a durability and thus is made of a cemented carbide. However, the cemented carbide is hard and difficult to process, and has a low efficiency in precision processing. Thus, the conventional art has a difficulty in efficiently producing the precision nozzle such as the reflow nozzle.

Japanese Patent Application Laid-Open Publication No. 2022-85914 (JP 2022-85914 A, Patent Document 1) discloses a nozzle for bonding an electronic component, the nozzle discharging an adhesive necessary for mounting an electronic component, wherein the nozzle consists of a tip and a body, the tip and the body are formed with a cemented carbide, the tip has a discharge through hole having an outlet with a diameter of not more than 50 μm, and the body has an internal space for feeding an adhesive to the tip.

Japanese Patent Application Laid-Open Publication No. 2022-89371 (JP 2022-89371 A, Patent Document 2) discloses a nozzle for bonding an electronic component, the nozzle discharging an adhesive necessary for mounting an electronic component, wherein the nozzle comprises a body being formed with a cemented carbide and consisting of a discharge through hole and an internal space for feeding an adhesive to the discharge through hole, the discharge through hole has an outlet with a diameter of not more than 50 μm.

The nozzles described in Patent Documents 1 and 2 each have a discharge through hole having an outlet with a diameter smaller than a diameter of an inlet in order to easily discharge a minute amount of an adhesive at a minute discharge diameter. Figures shown in these patent documents depict a nozzle that has a flow path with a two-step shape, including a flow path (a tapered flow path) with an inner diameter gradually decreased from the inlet toward the downstream direction and a flow path (a straight flow path) with the same (or a fixed) inner diameter from the tapered flow path toward the outlet. Moreover, Patent Documents 1 and 2 disclose that the diameter of the outlet is preferably not more than 30 μm from the viewpoint that the outlet enables the adhesive to be discharged suitably for high-density mounting.

Moreover, the discharge through hole is to have highly precise inner diameter and discharge axis, and Patent Documents 1 and 2 disclose that the method of forming the discharge through hole includes a method of boring a predetermined position to form a hole, a method of forming a hole by bonding, and a method of forming a hole by mold machining.

Furthermore, Patent Documents 1 and 2 disclose that, for forming of the body or the tip with a sintered compact of a metal powder, the method of forming the discharge through hole with high precision includes a method of providing the discharge through hole in forming the sintered compact and a method of producing the sintered compact and then forming the discharge through hole to the sintered compact by boring or other means.

Meanwhile, Japanese Patent Application Laid-Open Publication No. 2022-22419 (JP 2022-22419 A, Patent Document 3) discloses an electrical discharge machining method which includes providing a discharge electrode having a diameter larger than a diameter of a hole to be formed by boring, setting the discharge electrode as plus and a workpiece as minus, and feeding the discharge electrode while rotating at a feed rate of 30 to 200 μm/s to make a hole in the workpiece while consuming the discharge electrode.

### CITATION LIST

### Patent Literature

Patent Document 1: JP 2022-85914 A
Patent Document 2: JP 2022-89371 A
Patent Document 3: JP 2022-22419 A

### SUMMARY OF INVENTION

### Technical Problem

However, according to the processes for producing the nozzles described in Patent Documents 1 and 2, it is difficult to efficiently produce a precision nozzle with a cemented carbide. In particular, it is extremely difficult to produce itself a precision nozzle made of a cemented carbide with an outlet opening diameter of less than 45 μm (especially less than 30 μm). Patent Documents 1 and 2 fail to disclose any specific production process and also fail to disclose an outlet opening diameter of an actually produced nozzle.

For the nozzle of Patent Document 2, the flow path communicating with the outlet has a straight shape probably for the purpose of jetting the adhesive. However, some applications may use a tapered flow path. For example, a reflow nozzle using a solder ball is, in some cases, to have a tapered flow path communicating with an outlet in order to smoothly discharge a solder cream.

Moreover, Patent Document 2 discloses that boring by machining allows easy formation of a discharge through hole having a minute diameter. A typical machining method for making a hole includes drilling. A tool widely used for drilling is difficult to apply for cemented carbide machining due to a high density of a cemented carbide material, and thus electrical discharge is mostly selected for cemented carbide machining. A relatively new machining method for making a minute hole includes a method using a dedicated tool specialized in a material having a high hardness such as a cemented carbide and a special processing machine that can rotate the dedicated tool at high speed. However, when a minute hole having a diameter of about 40 μm is made by such a machining method, a drill bit to be used unavoidably has a short length in order to maintain the strength of the bit. This is because a long drill bit with a minute diameter would break during manufacture or use. Examples of commercially available drills that make it possible for a cemented carbide to perform the special micromachining as mentioned above include an ultra-small diameter drill for fine ceramic (“UVM-CERA (Special)” manufactured by OSG Corporation). However, for the ultra-small diameter drill, the length of the drill bit is selected according to the diameter of the drill bit. In a case where the diameter of the drill bit is 40 μm, the length of the drill bit is 0.4 mm. This is because a drill bit having an elongated shape with a minute diameter of about 40 μm and a length of more than 0.4 mm fails to maintain its strength sufficient for a drill bit. Thus, the machining described in Patent Document 2 fails to make a minute through hole with a hole diameter of about 40 μm in a cemented carbide having a thickness of more than 0.5 mm.

Furthermore, the electrical discharge machining method described in Patent Document 3 is not suitable for the production of a precision nozzle, because the method has a complicated discharge electrode control, has a low productivity, and deforms the electrode in the production process. In addition, this method also fails to produce a precision nozzle with an outlet opening diameter of less than 45 μm.

It is therefore an object of the present invention to efficiently produce a precision nozzle with a cemented carbide.

Another object of the present invention is to provide a novel precision nozzle made of a cemented carbide and a process for producing the precision nozzle, wherein the precision nozzle has a high productivity (or is produced with a high productivity), and has an outlet opening diameter of less than 45 μm and a tapered hole portion that is not thin (or not shallow).

### Solution to Problem

The inventors of the present invention made intensive studies to achieve the above objects and finally found that, in a process for producing a precision nozzle that is made of a cemented carbide and that contains a tapered hole path (or a tapered hole portion) extending to increase in inner diameter from an outlet (or a discharge outlet) as a starting point toward an inlet, a precision nozzle is efficiently produced with a cemented carbide through the following: a compacting step of compression-forming a raw powder using a transfer mold for forming a through hole to give a compact that has a blind hole with an opening corresponding to the inlet; a sintering step of sintering the resulting compact to give a sintered compact that has the blind hole with the opening corresponding to the inlet; an electrical discharge machining step of subjecting the sintered compact to electrical discharge machining using an electrode inserted to the blind hole of the sintered compact; and a grinding step of grinding the electrical-discharge-machined sintered compact from an opposite side to the opening, which corresponds to the inlet, to form the outlet. The present invention was accomplished based on the above findings.

That is, a process for producing a precision nozzle according to an aspect [1] of the present invention refers to a process for producing a precision nozzle, the precision nozzle comprising or being formed with a cemented carbide and having a through hole passing through from (or connecting) an inlet to an outlet, the through hole at least containing a tapered hole portion, and the tapered hole portion extending to increase in inner diameter (or extending in a direction increasing in inner diameter) from the outlet as a starting point toward the inlet, the process comprising:
a compacting step of compression-forming a raw powder using a transfer mold for forming the through hole to give a compact that has a blind hole with an opening corresponding to the inlet (or a blind hole having an opening corresponding to the inlet),
a sintering step of sintering the compact to give a sintered compact of (or corresponding to) the compact,
an electrical discharge machining step of subjecting the sintered compact to electrical discharge machining using an electrode inserted to the blind hole of the sintered compact, and
a grinding step of grinding the electrical-discharge-machined sintered compact from a side opposite to the opening, which corresponds to the inlet, to form the outlet.

An aspect [2] of the present invention is an aspect in which, in the aspect [1], the through hole has a circular, oval or elliptical, or polygonal cross-sectional shape.

An aspect [3] of the present invention is an aspect in which, in the aspect [2], the through hole has a circular cross-sectional shape.

An aspect [4] of the present invention is an aspect in which, in the compacting step according to any one of the aspects [1] to [3], the transfer mold has a shape corresponding to a shape of the through hole, the transfer mold contains a tapered portion corresponding in shape to the tapered hole portion, and the tapered portion has a conical, ovally or elliptically conical, or polygonal pyramid shape.

An aspect [5] of the present invention is an aspect in which, in the aspect [4], the tapered portion corresponding to in shape the tapered hole portion has a conical shape.

An aspect [6] of the present invention is an aspect in which, in the aspect [5], the transfer mold contains a conical portion corresponding in shape to the tapered hole portion, and the conical portion has a tip diameter of not more than 5 μm.

An aspect [7] of the present invention is an aspect in which, in the electrical discharge machining step according to any one of the aspects [1] to [6], the electrode has a shape corresponding to a shape of the transfer mold.

An aspect [8] of the present invention is an aspect in which, in the aspect [7], the electrode contains a conical portion corresponding in shape to the tapered hole portion, and the conical portion of the electrode, corresponding in shape to the tapered hole portion, has a tip diameter of not more than 5 μm.

An aspect [9] of the present invention is an aspect in which, in the grinding step according to any one of the aspects [1] to [8], a presence of a hole as the outlet is observed and an opening diameter of the hole is determined using image(s) of the ground surface taken with a camera.

An aspect [10] of the present invention is an aspect in which, in any one of the aspects [1] to [9], the through hole consists of the tapered hole portion and a cylindrical hole portion extending from the tapered hole portion to the inlet.

An aspect [11] of the present invention is an aspect in which, in any one of the aspects [1] to [10], the outlet has an opening diameter of less than 30 μm.

An aspect [12] of the present invention is an aspect in which, in any one of the aspects [1] to [11], the precision nozzle is a nozzle for an electronic component.

An aspect [13] of the present invention is an aspect in which, in any one of the aspects [1] to [12], the precision nozzle is a reflow nozzle for discharging a molten solder ball,

The present invention also includes a precision nozzle according to an aspect [14], the precision nozzle
comprising or being formed with a cemented carbide,
having a through hole passing through from (or connecting) an inlet from an outlet,
the through hole containing a tapered hole portion extending to increase in inner diameter (or extending in a direction increasing in inner diameter) from the outlet toward the inlet,
the outlet having an opening diameter (or an outlet opening diameter) of less than 45 μm, and
the tapered hole portion having a length of not less than 1 mm in a nozzle axial direction.

A aspect [15] of the present invention is an aspect in which, in the aspect [14], the length of the tapered hole portion in the nozzle axial direction is not less than 10 times as long as the opening diameter of the outlet.

An aspect [16] of the present invention is an aspect in which, in the aspect [14] or [15], the outlet has a circular shape, and the outlet has a roundness of not more than 5 μm.

An aspect [17] of the present invention is an aspect in which, in any one of the aspects [14] to [16], an outline shape of the precision nozzle at the outlet is an isotropic shape, the outlet has a circular shape, and the outline shape and the outlet (or the shape of the outlet) have a concentricity of not more than 10 μm.

An aspect [18] of the present invention is an aspect in which, in any one of the aspects [14] to [17], the tapered hole portion has a slope angle of 3 to 60°.

An aspect [19] of the present invention is an aspect in which, in any one of the aspects [14] to [18], the outlet has an opening diameter of less than 30 μm.

An aspect [20] of the present invention is an aspect in which, in any one of the aspects [14] to [19],
the outlet has an opening diameter of not less than 1 μm to less than 30 μm,
the tapered hole portion has a length of 1 to 20 mm in the nozzle axial direction,
the length of the tapered hole portion in the nozzle axial direction is not less than 100 times as long as the opening diameter of the outlet,
the outlet has a circular shape, and the outlet has a roundness of not more than 5 μm,
an outline shape of the precision nozzle at the outlet is a circular shape, and the outline shape and the outlet (or the shape of the outlet) have a concentricity of not more than 10 μm, and
the tapered hole portion has a slope angle of 4 to 50°.

An aspect [21] of the present invention is an aspect in which, in any one of the aspects [14] to [20], the cemented carbide is an alloy containing tungsten carbide.

### Advantageous Effects of Invention

According to the present invention, the precision nozzle with a cemented carbide is efficiently produced by the production process including a combination of the compacting step using the specific transfer mold, the sintering step, the die-sinking electrical discharge machining step using the specific electrode, and the grinding step of grinding the sintered compact formed into the specific shape by electrical discharge machining. In particular, the present invention achieves easy or simple production of the novel precision nozzle made of a cemented carbide and having an outlet opening diameter of less than 45 μm and a tapered hole portion that is not thin (or not shallow).

### BRIEF DESCRIPTION OF DRAWINGS

FIG. 1 is a schematic perspective view showing a precision nozzle according to an embodiment of the present invention.

FIG. 2 is a schematic cross-sectional view taken along line I-I in FIG. 1.

FIG. 3 is a schematic cross-sectional view showing a precision nozzle according to another embodiment of the present invention.

FIG. 4 is a schematic cross-sectional view showing a precision nozzle according to still another embodiment of the present invention.

FIG. 5 is a schematic cross-sectional view showing a precision nozzle according to still another embodiment of the present invention.

FIG. 6 is a view for explaining an opening diameter of an outlet and a depth of a tapered hole portion in the precision nozzle of FIG. 4.

FIG. 7 is a view for explaining an opening diameter of an outlet and a depth of a tapered hole portion in the precision nozzle of FIG. 5.

FIG. 8 is a schematic process drawing for explaining a compacting step and an electrical discharge machining step in a process for producing a precision nozzle according to an embodiment of the present invention.

FIG. 9 is a schematic process drawing for explaining a sintering step and an electrical discharge machining step in a process for producing a precision nozzle according to an embodiment of the present invention.

FIG. 10 is a schematic process drawing for explaining a grinding step in a process for producing a precision nozzle according to an embodiment of the present invention.

FIG. 11 is a photomicrograph of a tip of a transfer mold (a press pin) used in Examples.

FIG. 12 is a photomicrograph of a tip of an electrode used in Examples.

FIG. 13 is a photomicrograph of a tip of a precision nozzle obtained immediately after an outlet of a through hole is opened in Example 1.

FIG. 14 is a cross-sectional photomicrograph of a tip of a precision nozzle obtained in Example 1.

FIG. 15 is a photomicrograph of a tip of a precision nozzle in which an outlet of a through hole is opened in Example 2.

FIG. 16 is a photomicrograph of a tip of a precision nozzle in which an outlet of a through hole is opened in Example 3.

FIG. 17 is a photomicrograph of a tip of a precision nozzle in which an outlet of a through hole is opened in Example 4.

FIG. 18 is a photomicrograph of a tip of a precision nozzle in which an outlet of a through hole is opened in Example 5.

FIG. 19 is a photomicrograph of a tip of a precision nozzle in which an outlet of a through hole is opened in Example 6.

FIG. 20 is a photomicrograph of a tip of a precision nozzle in which an outlet of a through hole is opened in Example 8.

FIG. 21 is a photomicrograph of a tip of a precision nozzle in which an outlet of a through hole is opened in Example 9.

### DESCRIPTION OF EMBODIMENTS

### [Material of Precision Nozzle]

The precision nozzle of the present invention is made of (or contains) a cemented carbide as a material, and the cemented carbide is not limited to a specific one. Representative Examples of the cemented carbide may include an alloy containing a carbide of any of groups 4 to 6 metals of the Periodic Table. In particular, an alloy containing tungsten carbide WC (a WC-based alloy) is widely used.

The WC-based alloy may be formed with WC as a main component, and a binding component which provides a liquid phase by sintering to give a binder phase.

Examples of the binding component may include groups 8 to 10 metals of the Periodic Table, for example, manganese Mn, iron Fe, cobalt Co, and nickel Ni. Such a binding component may be used alone or in combination of two or more. Among them, cobalt Co and/or nickel Ni is preferred, and cobalt Co is particularly preferred.

A ratio of the binding component (in particular, Co) relative to 100 parts by mass of tungsten carbide may be not more than 30 parts by mass, and is preferably 0.5 to 25 parts by mass and further preferably 1 to 20 parts by mass,

The WC-based alloy may further contain a metal carbide (another metal carbide) in addition to the main component. Examples of another metal carbide may include titanium carbide TiC, niobium carbide NbC, tantalum carbide TaC, and chromium carbide Cr₃C₂. Such another metal carbide may be used alone or in combination of two or more. Among them, TiC, TaC, or Cr₃C₂ is preferred.

The WC-based alloy may further contain a metal simple substance (another metal simple substance) in addition to the binding component. Examples of another metal simple substance may include titanium Ti, zirconium Zr, vanadium V, niobium Nb, tantalum Ta, chromium Cr, molybdenum Mo, tungsten W, and rhenium Re. Such another metal simple substance may be used alone or in combination of two or more. Among them, V and/or Cr is preferred.

A ratio of another metal simple substance relative to 100 parts by mass of the whole WC-based alloy may be not more than 5 parts by mass, and is preferably 0.1 to 3 parts by mass and further preferably 0.2 to 2 parts by mass.

The WC-based alloy may further contain a carbon source C (such as a carbon black) or may contain an unavoidable impurity.

Examples of the WC-based alloy may include a WC—Co-based alloy, a WC—TiC—Co-based alloy, a WC—TaC—Co-based alloy, a WC—TiC—TaC—Co-based alloy, a WC—Ni-based alloy, and a WC—Ni—Cr-based alloy. Among them, the WC—Co-based alloy is widely used.

### [Shape of Precision Nozzle]

The precision nozzle of the present invention is in any shape, without limitation, that has a through hole passing through from (or connecting) an inlet to an outlet, the through hole at least containing a tapered hole portion extending to increase in inner diameter (or extending in a direction increasing in inner diameter) from the outlet as a starting point toward the inlet. Hereinafter, the shape of the nozzle of the present invention will be described in detail with reference to the drawings.

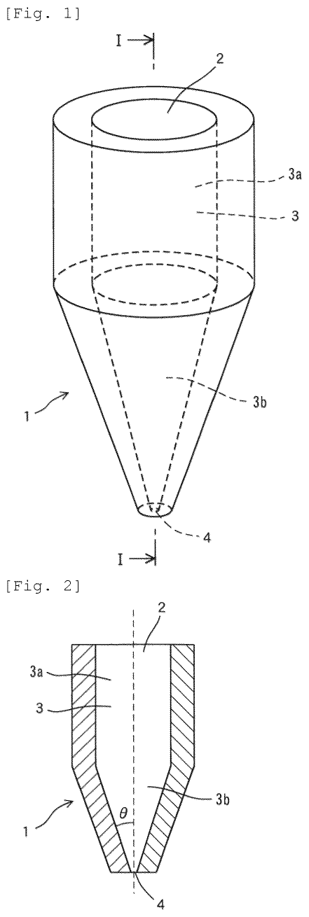

FIG. 1 is a schematic perspective view showing a precision nozzle according to an embodiment of the present invention. FIG. 2 is a schematic cross-sectional view taken along line I-I in FIG. 1.

This precision nozzle 1 has a through hole 3 having a circular cross-sectional shape; the through hole 3 passes through from a circular inlet 2, for injecting an object to be discharged, to a circular outlet 4, for discharging the object. The through hole 3 functions as a passage (or a flow path) through which the object to be discharged, such as a gas, a liquid, and a solid, passes. The through hole 3 includes a tapered hole portion 3b and a cylindrical hole portion 3a; the tapered hole portion 3b extends to increase in inner diameter from the outlet 4 as a starting point toward the inlet 2, and the cylindrical hole portion 3a extends with a substantially the same (or a fixed) inner diameter from an upstream end of the tapered hole portion 3b to the inlet 2. An outer shape corresponding to the tapered hole portion 3b is tapered toward the outlet 4. Specifically, the tapered hole portion 3b has a slope angle θ (an angle between an axis of the nozzle and an inclined wall of the tapered hole portion) of 10° with respect to the axis of the nozzle,

In the precision nozzle 1 shown in FIG. 1, the outlet 4 opened at a tip of the tapered hole portion 3b has an opening diameter (a diameter) φ of about 20 μm. Conventional thin precision nozzles have an outlet opening diameter φ of about 40 μm at a minimum. This is because that it is difficult to produce a precision nozzle with an outlet opening diameter (or a hole diameter) of less than 30 μm by the conventional production process as described in Patent Document 2. Patent Document 2 fails to disclose the conventional production process in detail. In order to form a minute outlet with high precision, a conventional technique may typically include forming a minute outlet by subjecting a sintered compact having a hole corresponding to an inside of a nozzle to an electrical discharge machining from the outlet (or the outlet side) toward the inside of the nozzle (from a side opposite to an inlet). This is because that, in order to form a minute outlet by electrical discharge machining, a shape corresponding to a shape of an electrode is easily formed at the entrance of the machining while a uniform shape corresponding to the shape of the electrode is difficult to maintain as the machining progresses. In particular, an electrode fine and flexible like a hair is to be used in order to form the minute outlet, which makes the maintenance of the corresponding shape even more difficult. Thus, a through hole formed by such a conventional machining method is a through hole having a shape as shown the drawings of Patent Document 2, that is, a through hole having a cylindrical hole portion extending from an outlet as a starting point toward an inlet. Moreover, use of the flexible and minute electrode makes a position adjustment with respect to the inlet (or the inlet side) extremely difficult, and it is difficult to produce a nozzle highly precisely.

Specifically, the method including finally machining from the outlet (or the outlet side) to form the through hole fails to produce a precision nozzle that has a tapered hole portion with a shape extending to increase in inner diameter from the outlet toward the inlet as shown in FIG. 1. Thus, although the precision nozzle obtained by the conventional method such as Patent Document 2 has a minute outlet having an opening diameter of about 40 μm, a hole portion extending from the outlet do not have a shape extending to increase in inner diameter from the outlet toward the inlet. In particular, for a precision nozzle having a tapered hole portion that is not thin (or not shallow), it is difficult to form a minute outlet. For example, the conventional method fails to produce a precision nozzle that has an outlet with a minute opening diameter of less than 45 μm and has a tapered hole portion extending to increase in inner diameter from the outlet toward the inlet.

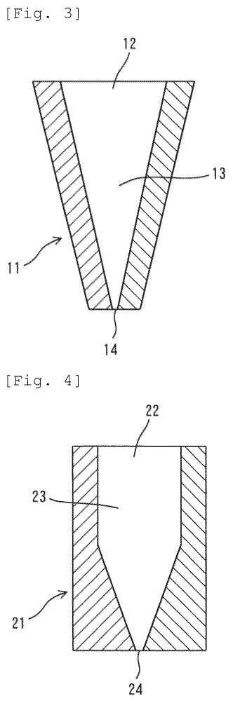

FIG. 3 is a schematic cross-sectional view showing a precision nozzle according to another embodiment of the present invention. Such a precision nozzle 11 also has a through hole 13 passing through from a circular inlet 12 to a circular outlet 14, and the through hole 13 differs in shape from the through hole 3 shown in FIGS. 1 and 2. Specifically, for the precision nozzle 11, the through hole 13 consists of a tapered hole portion continuously extending to increase in inner diameter from the outlet 14 to the inlet 12.

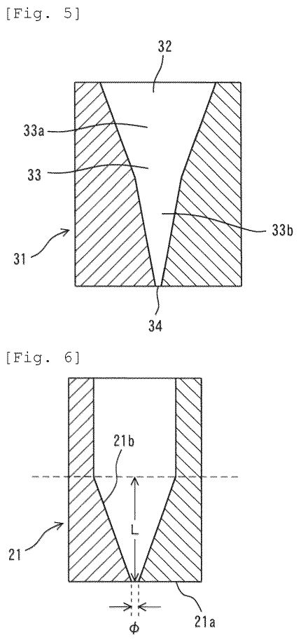

FIG. 4 is a schematic cross-sectional view showing a precision nozzle according to still another embodiment of the present invention. Such a precision nozzle 21 has a through hole 23 passing through from a circular inlet 22 to a circular outlet 24, and the through hole 23 has the same shape as the through hole of the precision nozzle shown in FIG. 1. The precision nozzle 21 differs from the precision nozzle shown in FIG. 1 in that the nozzle 21 has an external cylindrical (or columnar) shape. The precision nozzle shown in FIG. 1 is usually shaped by grinding the precision nozzle shown in FIG. 4.

FIG. 5 is a schematic cross-sectional view showing a precision nozzle according to still another embodiment of the present invention. Such a precision nozzle 31 has a through hole 33 passing through from a circular inlet 32 to a circular outlet 34. The through hole 33 consists of a first tapered hole portion 33b and a second tapered hole portion 33a; the first tapered hole portion 33b extends to increase in inner diameter from the outlet 34 as a starting point toward the inlet 32, and the second tapered hole portion 33a extends to increase in inner diameter from an upstream end of the first tapered hole portion 33b toward the inlet 32. In this embodiment, the second tapered hole portion 33a has a slope angle larger than the first tapered hole portion 33b.

The cross-sectional shape of the through hole (in particular, the tapered hole portion) (the cross-sectional shape perpendicular to a length direction or axial direction thereof) is not limited to a specific one. Examples of the cross-sectional shape may include a circular shape, an oval shape, and a polygonal shape. The cross-sectional shape may be an anisotropic shape such as an oval shape and a rectangular shape, preferably an isotropic shape such as a circular shape, a square shape, and a regular hexagonal shape, and particularly preferably a circular shape. The shape of the outlet is the same as the cross-sectional shape of the through hole.

For the outlet having a circular shape (or circular outline), the process of the present invention can make a circular outlet roundness small, since the process includes a combination of specified compacting step, electrical discharge machining step, and grinding step. The roundness of the outlet may be not more than 5 μm (for example, about 0.1 to 5 μm), and is preferably not more than 4 μm (for example, 0.3 to 4 μm), further preferably not more than 3 μm, more preferably not more than 1 μm, and most preferably not more than 0.5 μm. In a case where the roundness is excessively large, the precision nozzle may decrease in function.

For the outlet having a circular shape, the ratio of the roundness of the outlet (or the outlet roundness) relative to the opening diameter of the outlet (or the outlet opening diameter) may be not more than 0.3, preferably not more than 0.2, and further preferably not more than 0.1. For example, the ratio is 0.001 to 0.3, preferably 0.005 to 0.25, further preferably 0.01 to 0.2, more preferably 0.03 to 0.15, and most preferably 0.05 to 0.1. In a case where the ratio of the roundness relative to the opening diameter is excessively large, the precision nozzle may decrease in function.

In this description and claims, the outlet roundness can be measured in accordance with Japanese Industrial Standards (JIS) B 0621-1984, specifically, can be measured using an optical image measuring instrument (“SmartScope ZIP-300” manufactured by OGP).

In a case where an outline shape of the precision nozzle at the outlet is an isotropic shape (in particular, a circular shape) and the outlet has a circular shape, the outline shape and the outlet may have a concentricity of not more than 10 μm, preferably not more than 8 μm, further preferably not more than 7 μm, and more preferably not more than 5 μm, and, for example, has a concentricity of 0.1 to 10 μm, preferably 0.3 to 8 μm, further preferably 0.5 to 7 μm, more preferably 1 to 6 μm, and most preferably 1.5 to 5 μm. In a case where the concentricity is excessively large, the precision nozzle may decrease in function.

In this description and claims, the above-mentioned concentricity is defined in accordance with JIS B 0021-1998, specifically, can be measured using an optical image measuring instrument (“SmartScope ZIP-300” manufactured by OGP). In this description and claims, the above-mentioned concentricity means a difference between the center of the circular outline shape and the center of the circular outlet (or a center-to-center distance between an outer circle or outer circumference and an inner circle or inner circumference).

The precision nozzle of the present invention may have an outlet opening diameter φ (a hole diameter of a downstream outlet port of the tapered hole portion) of less than 45 μm, and has an outlet opening diameter φ of preferably less than 40 μm, further preferably less than 35 μm, and more preferably less than 30 μm. The outlet opening diameter φ may be not less than 1 μm. In particular, in the precision nozzle, the outlet opening diameter may be not more than 25 μm (particularly not more than 20 μm), and is, for example, 1 to 25 μm, preferably 2 to 20 μm, further preferably 3 to 10 μm, and more preferably 4 to 7 μm.

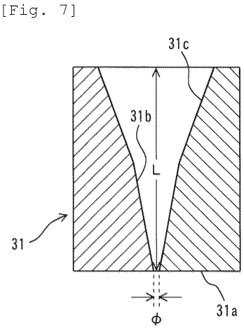

In this description and claims, the outlet opening diameter φ can be measured using, for example, an optical image measuring instrument (“SmartScope ZIP-300” manufactured by OGP), The outlet opening diameter means a maximum diameter; for the outlet having a circular shape, the outlet opening diameter means a diameter of the circular shape, and for the outlet having a polygonal or anisotropic shape, the outlet opening diameter means, for example, a major axis of the polygonal or anisotropic shape. FIG. 6 and FIG. 7 show an outlet opening diameter φ of the precision nozzle of FIG. 4 and that of FIG. 5, respectively,

The tapered hole portion may have a length L (or a depth) in a nozzle axial direction of not less than 1 mm or may have a length L of not more than 30 mm. Specifically, the depth of the tapered hole portion may be selected from a range of about 1 to 30 m, and is, for example, 1 to 20 mm, preferably 2 to 10 mm, further preferably 2.5 to 8 mm, more preferably 3 to 5 mm, and most preferably 3.5 to 4.5 mm. In a case where the depth of the tapered hole portion is excessively short, it may be difficult to form a minute outlet.

In this description and claims, the length of the tapered hole portion in the nozzle axial direction means the shortest distance between an upstream opening of the tapered hole portion and the center of the outlet. FIG. 6 and FIG. 7 show a depth L of the tapered hole portion in the precision nozzle of FIG. 4 and that of FIG. 5, respectively,

The precision nozzle of the present invention is characterized in that the length of the tapered hole portion relative to the outlet opening diameter is large and that the tapered hole portion is not thin. It is difficult to form a precision nozzle having a tapered hole portion that is not thin with a cemented carbide, in particular, a conventional machining fails to produce a tapered hole portion having an outlet opening diameter of less than 45 μm with a cemented carbide. The production of the precision nozzle by the production process of the present invention allows the formation of a tapered hole portion having a minute outlet.

In the precision nozzle of the present invention, the depth L of the tapered hole portion relative to the outlet opening diameter φ is relatively large, and the tapered hole portion is not thin. The depth L of the tapered hole portion may be 10 times or more as large as the outlet opening diameter φ, and is, for example, 30 times or more, preferably 50 times or more, further preferably 80 times or more, more preferably 100 times or more, and most preferably 200 times or more, as large as the outlet opening diameter φ, and may for example be 50 to 10000 times (particularly 100 to 1000 times) as large as the outlet opening diameter φ.

The slope angle θ of the tapered hole portion [the angle between the axis of the nozzle and the inclined wall (an inner wall of the tapered hole portion)] with respect to the axis of the nozzle is, for example, 3 to 60°, preferably 4 to 50°, further preferably 5 to 30°, more preferably 7 to 20°, and most preferably 8 to 15°. In a case where the slope angle θ is excessively small, the function as the precision nozzle, for example, a reflow nozzle using a solder ball, may be decreased. In contrast, in a case where the slope angle θ is excessively large, it may be difficult to form a minute outlet.

The inner wall of the tapered hole portion has an excellent smoothness. The inner wall surface of the tapered hole portion has an arithmetic average roughness Ra of, for example, 5 to 1000 μm, preferably 10 to 800 μm, further preferably 30 to 500 μm, more preferably 50 to 300 μm, and most preferably 100 to 200 μm. FIG. 6 shows an inner wall 21b in the precision nozzle of FIG. 4, and FIG. 7 shows inner walls 31b, 31c in the precision nozzle of FIG. 5.

The tip surface (the downstream tip surface) of the outlet of the precision nozzle of the present invention also has an excellent smoothness, since the tip surface is formed through a grinding step as described later. The tip surface (the ground surface) of the outlet has an arithmetic average roughness Ra of, for example, 1 to 100 μm, preferably 5 to 50 μm, further preferably 8 to 40 μm, more preferably 10 to 30 μm, and most preferably 15 to 25 μm. FIG. 6 shows a tip surface 21a of the outlet in the precision nozzle of FIG. 4, and FIG. 7 shows a tip surface 31a of the outlet in the precision nozzle of FIG. 5.

In this description and claims, the arithmetic average roughness Ra of the inner wall surface of the tapered hole portion and that of the tip surface of the outlet can be measured by a method in accordance with JIS B 0601-2001, specifically, can be measured using a contour measuring instrument (“SURFCOM 2600G-13” manufactured by TOKYO SEIMITSU CO., LTD.).

The shape of the through hole of the precision nozzle of the present invention is not limited to a specific one and may be any shape that contains the above-mentioned tapered hole portion. The shape of the upstream hole (or the upstream opening) of the above-mentioned tapered hole portion is not limited to a specific one and may suitably be selected depending on the intended use, the species of the object to be discharged, and/or others. Thus, the shape of the through hole may be, in addition to the shape shown in FIG. 1 or FIG. 2, for example, a combined shape of the above-mentioned tapered hole portion and another tapered hole portion, a combined shape of the above-mentioned tapered hole portion and other two or more tapered hole portions, or a combined shape of the above-mentioned tapered hole portion, a non-tapered hole portion (in particular, a cylindrical hole portion) and another tapered hole portion.

The non-tapered hole portion is not limited to a specific one and may be any shape that communicates with the tapered hole portion. Examples of the non-tapered hole portion may include a cylindrical hole portion, and in addition, a non-tapered hole portion having an internal elliptic cylindrical or polygonal prism shape.

For the combined shape of the tapered hole portion and the non-tapered hole portion (particularly a cylindrical hole portion), the non-tapered hole portion has a flow path (particularly a cylindrical flow path) with an inner diameter of, for example, 0.5 to 10 mm, preferably 0.8 to 5 mm, further preferably 1 to 3 mm, and more preferably 1.2 to 2 mm.

### [Compacting Step]

The process for producing the precision nozzle of the present invention includes a compacting step of compression-forming a raw powder using a transfer mold for forming the through hole of the nozzle to give a compact that has a blind hole with an opening corresponding to the inlet.

### (Raw Powder)

The raw powder may suitably be selected depending on the species of a cemented carbide and typically contains constituents of the cemented carbide, each in a particle form. For the WC-based alloy, the raw powder may contain a WC particle and a binding component particle, and if necessary another metal carbide particle and/or another metal particle.

The WC particle has an average particle diameter (or an average particle size) of, for example, 0.1 to 15 μm, preferably 0.12 to 12 μm, and further preferably 0.2 to 10 μm.

The average particle diameter of the binding component particle (in particular, a Co particle) is not limited to a specific one since the binding component particle is molten to give a binder phase, and the average particle diameter of the binding component particle is, for example, 0.1 to 5 μm, preferably 0.5 to 3 μm, and further preferably 1 to 2.5 μm.

Another metal carbide particle and another metal particle each have an average particle diameter of, for example, 0.1 to 5 μm, preferably 0.5 to 3 μm, and further preferably 1 to 2.5 μm.

The ratio of these constituents in the raw powder of the WC-based alloy corresponds to the ratio of the constituents in the cemented carbide mentioned above.

In the compacting (compression-forming), a binder may be blended with such a raw powder. The binder preferably includes a binder that can be removed by heating in the process of pre-sintering or sintering. Examples of such a binder may include a straight- or branched-chain aliphatic hydrocarbon such as a paraffin and a wax, and a polyethylene glycol. The binder may be in a particle form. Moreover, the binder may be blended together with an alcohol such as ethanol, and/or a benzine.

The ratio of the binder relative to 100 parts by mass of the raw powder may be not more than 20 parts by mass, and is preferably 0.1 to 10 parts by mass and further preferably 0.2 to 7 parts by mass.

### (Compression-Forming)

In the compression-forming of the raw powder, use of the transfer mold for forming the through hole of the nozzle allows the production of a compact (a green compact) that has a blind hole (corresponding to what is called “a prepared hole”) with an opening corresponding to the inlet.

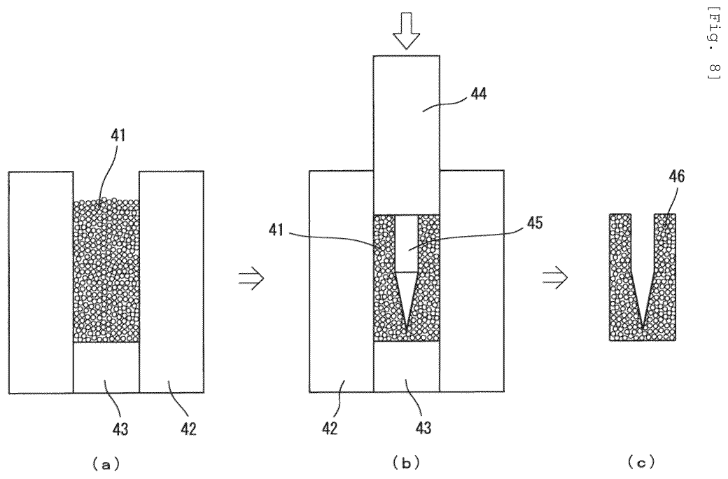

An example of the compacting step is explained with reference to FIG. 8. As shown in FIG. 8, in the compacting step, first, a tubular mold, such as a cylindrical mold, formed by a die 42 and a lower punch 43 is filled with a raw powder 41 for forming a cemented carbide [FIG. 8(a)]. Secondly, an upper punch 44 having a press pin 45 attached thereto that is a transfer mold is inserted in the tubular mold to press the raw powder 41, thereby the press pin 45 entering the inside of the filled raw powder 41, and thus the shape of the press pin 45 is transferred to a compact (or a green compact) of the raw powder 41 [FIG. 8(b)]. Finally, the green compact of the raw powder 41 is taken out from the tubular mold to give a cylindrical (or columnar) green compact 46 having the above-mentioned blind hole [FIG. 8(c)].

The press pin 45 that is a transfer mold has a cylindrical shape with a conical tip (or a cylindrical shape having a tip with a conical shape). In the compacting step, the press pin 45 having the above-mentioned shape is inserted from the conical tip thereof in the raw powder 41 filled in the mold while pressurizing, thereby allowing the raw powder 41 to be compacted and allowing the shape of the press pin 45 that is a transfer mold to be transferred to the green compact of the raw powder 41 as the shape of the above-mentioned blind hole. A blind hole formed in this manner does not pass through the green compact, different from a through hole of an objective nozzle, and can form a minute outlet at a bottom tip of the blind hole in combination with the after-mentioned die-sinking electrical discharge machining step and grinding step.

The shape of the transfer mold is not limited to a specific one and may be any shape that can transfer a green compact that has a blind hole with an opening corresponding to the above-mentioned inlet. This is because that the formation of the blind hole in the green compact allows the formation of a minute outlet by grinding a sintered compact of the green compact from a side opposite to the opening in the after-mentioned grinding step. In particular, an outlet having a minute opening diameter can easily be formed by making the tip shape (the bottom shape) of the blind hole into a minute tapered shape.

Such a shape of the transfer mold corresponds to the shape of the through hole. From a viewpoint of easy formation of a minute outlet, it is preferred that the shape of the transfer mold correspond to the shape of the through hole and that the shape of the tapered portion corresponding to the tapered hole portion be conical. Specifically, in the shape of the transfer mold, the shape corresponding to the shape of the through hole may be as follows: only a shape of a portion corresponding to the tapered hole portion almost but not completely corresponds to the shape of the through hole (a conical shape having a tip extending from the outlet in the shape of the tapered hole portion). Also, forming the conical portion of the transfer mold having the same taper angle as the tapered hole portion of the above-mentioned precision nozzle facilitates the formation of a minute outlet. Moreover, the green compact shrinks by about 20 to 30% in the after-mentioned sintering step, and thus the shape of the transfer mold may be formed in a slightly enlarged shape of the through hole in response to the shrinkage rate,

The conical portion of the transfer mold preferably has a small tip diameter in light of easy formation of the minute outlet of the precision nozzle. The tip diameter may be selected in response to an objective opening diameter of the outlet and may for example be not more than 10 μm (e.g., 1 to 10 μm), and the tip diameter is preferably not more than 7 μm (e.g., 2 to 7 μm) and further preferably not more than 5 μm (e.g., 3 to 5 μm). In a case where the tip diameter is excessively large, it may be difficult to easily produce a precision nozzle having a minute outlet diameter.

A forming pressure of the compression-forming is, for example, 50 to 300 MPa, preferably 100 to 250 MPa, and further preferably 150 to 200 MPa,

### [Sintering Step]

The process for producing the precision nozzle of the present invention further includes a sintering step of sintering the green compact obtained in the above-mentioned compacting step to give a sintered compact that has the blind hole with the opening corresponding to the above-mentioned inlet.

In the sintering step, the green compact is densified and unified by allowing the binding component particle to melt to give a liquid phase, thus giving a sintered compact. If necessary, the green compact may be subjected to pre-sintering (pre-calcining) before a main-sintering of allowing the binding component particle to melt, where the pre-sintering is heated at a temperature lower than the main-sintering temperature. In a case where the green compact contains the binder, the binder may be removed in the pre-sintering.

The pre-sintering temperature is, for example, 100 to 1000° C., preferably 300 to 900° C., and further preferably 500 to 800° C. The pre-sintering may be carried out either under a normal or ordinary pressure or under a reduced pressure, and is preferably carried out under a reduced pressure. The pre-sintering time is, for example, 2 to 48 hours, preferably 4 to 12 hours, and further preferably 6 to 10 hours.

The main-sintering temperature is, for example, 1200 to 1600° C., preferably 1250 to 1550° C., and further preferably 1300 to 1500° C. The main-sintering may be carried out under a normal or ordinary pressure or under a reduced pressure (or under vacuum), or may be carried out under a normal or ordinary pressure or under an applied pressure. The main-sintering time is, for example, 1 to 48 hours, preferably 2 to 24 hours, and further preferably 3 to 20 hours.

### [Electrical Discharge Machining Step]

The process for producing the precision nozzle of the present invention further includes an electrical discharge machining step (a die-sinking electrical discharge machining step) of subjecting the sintered compact to electrical discharge machining using an electrode inserted to the blind hole of the sintered compact.

The sintered compact, which is a compact densified by sintering the green compact obtained in the compacting step, is shaped into a state close to a shape of an objective precision nozzle (a near net shape) by using the transfer mold and the shrinkage rate. According to the present invention, in order to produce a precision nozzle having a passage with an intended precise shape for passing the object to be discharged and an intended minute outlet, the sintered compact is further shaped into a shape close to the through hole of the objective precision nozzle by the die-sinking electrical discharge machining, and this can achieve production of a precision nozzle having a minute outlet. In particular, the present invention uses a specified electrode in the die-sinking electrical discharge machining step, thereby enabling precise formation of an outlet having an opening diameter of less than 30 μm through the after-mentioned grinding step, and formation of an outlet having an opening diameter of not more than 20 μm, which has not been able to be formed by a conventional production process. In this case, the effects of the near net shape forming by the transfer mold may include low electrode consumption in the die-sinking electrical discharge machining, improvement in precision of the precision processing, and cost reduction.

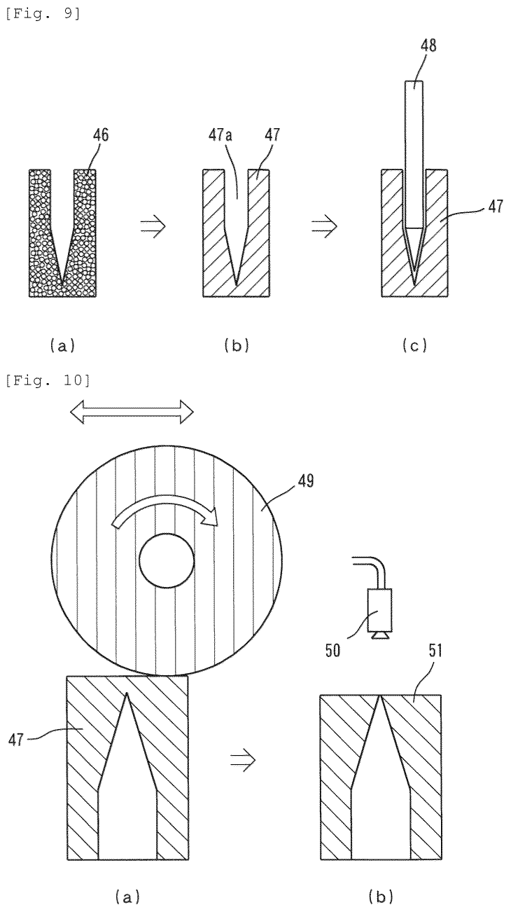

A series of flow from the sintering step to the die-sinking electrical discharge machining step is explained using FIG. 9. As shown in FIG. 9, the green compact 46 obtained in the compacting step [FIG. 9(a)] is densified and unified in the sintering step to give a sintered compact 47 having a nearly net-shaped hole 47a [FIG. 9(b)]. The inner wall of the hole 47a is finished by subjecting the hole 47a to electrical discharge machining using an electrode 48 having a shape corresponding to the through hole of the precision nozzle, and thus the shape of the electrode 48 is precisely transferred to the hole 47a of the sintered compact 47 [FIG. 9(c)].

The electrode 48 also has a shape corresponding to the shape of the press pin 45 used in the compacting step, specifically a cylindrical shape with a conical tip. In the die-sinking electrical discharge machining step, transferring the shape of the electrode using the electrode 48 having such a conical shape brings the hole 47a of the sintered compact 47 more closer to a shape of a through hole of an objective precision nozzle, and makes it easier to form a minute outlet in the after-mentioned grinding step.

In order to easily form an objective shape of the through hole, the shape of the electrode preferably corresponds to the shape of the through hole; in order to easily open a minute outlet in the after-mentioned grinding step, the shape of the electrode preferably corresponds to the shape of the through hole and has a conical shape as the shape of the tapered portion corresponding to the tapered hole portion. Specifically, in the shape of the electrode, the shape corresponding to the shape of the through hole may be as follows: only a shape of a portion corresponding to the tapered hole portion almost but not completely corresponds to the shape of the through hole (a conical shape having a tip extending from the outlet in the shape of the tapered hole portion). Thus, the conical portion of the electrode preferably has the same taper angle as the tapered hole portion of the above-mentioned precision nozzle.

The conical portion of the electrode preferably has a small tip diameter in light of easy formation of the minute outlet of the precision nozzle. The tip diameter may be selected in response to an objective opening diameter of the outlet and may for example be not more than 10 μm (e.g., 1 to 10 μm), and the tip diameter is preferably not more than 7 μm (e.g., 2 to 7 μm) and further preferably not more than 5 μm (e.g., 3 to 5 μm). In a case where the tip diameter is excessively large, it may be difficult to easily produce a precision nozzle having a minute outlet diameter.

A material of the electrode preferably contains tungsten W. The material is further preferably tungsten simple substance or an alloy of tungsten and another metal (for example, an alloy of tungsten and copper), and more preferably tungsten simple substance,

In the electrical discharge machining, a gap (a discharge gap) between the electrode and the hole (blind hole) is, for example, 10 to 30 μm, preferably 10 to 20 μm, and further preferably 5 to 10 μm. The condition of the electrical discharge machining preferably includes machining using 5 to 8 electrodes, for example, considering productivity and maintenance of precision.

### [Grinding Step]

The process for producing the precision nozzle of the present invention includes a grinding step of grinding the electrical-discharge-machined sintered compact obtained in the above-mentioned die-sinking electrical discharge machining from a side opposite to the opening, which will serve to the inlet, to form (or open) an outlet. The sintered compact subjected to the die-sinking electrical discharge machining step has a hole (a blind hole) formed inside thereof, wherein the blind hole has a shape corresponding to the through hole of the precision nozzle, and a conical tip corresponding to the bottom of the blind hole does not pass through the sintered compact. In the grinding step, the sintered compact is ground to the conical tip of the blind hole, thus forming (or opening) an outlet.

A grinding method may include a conventional grinding method, for example, may use a grinding machine provided with a disk grinding wheel (e.g., a surface grinder).

In the grinding step, a method of checking the presence of a hole as the outlet and an opening diameter of the hole (or a method of observing the presence of a hole as the outlet and determining an opening diameter of the hole) is not limited to a specific one. The checking method (or the observation and determination method) may use passing of gas or liquid, image(s) taken with a camera, or other means. Among them, in light of convenience and/or others, preferred is a checking method using image(s) taken with a camera.

FIG. 10 explains a grinding step which adopts a checking method using image(s) of a ground surface taken with a camera. In the grinding step, a surface of the sintered compact 47 subjected to the die-sinking electrical discharge machining step is ground with a grinding machine 49 having a disk grinding wheel while rotating and moving the disk grinding wheel [FIG. 10(a)], thus grinding the surface from an opposite side (a back side) to the opening corresponding to the inlet, for a predetermined time; then, an image of the ground surface is checked using a camera 50 [FIG. 10(b)]. If the results of the image check show that the ground surface has no hole, the grinding is repeated for a predetermined time and/or at a predetermined distance until a hole is observed. After the observation of the hole, the opening diameter of the hole is measured using a measuring instrument. If the opening diameter does not reach an objective outlet diameter, the grinding is repeated for a predetermined time and/or at a predetermined distance until the objective opening diameter is shown, thus producing a precision nozzle 51 having an objective outlet.

In the grinding method using the grinding machine provided with the disk grinding wheel, a peripheral speed of the disk grinding wheel is, for example, about 15 to 35 m/s, preferably about 20 to 30 m/s, and further preferably about 24 to 28 m/s. A rotational speed of a rotation axis of the disk grinding wheel is, for example, 1400 to 2600 rpm, preferably 1600 to 2400 rpm, and further preferably 1800 to 2200 rpm. In a case where the speed is excessively low, the productivity may be lowered. In contrast, in a case where the speed is excessively high, it may be difficult to adjust the opening diameter of the outlet.

The grinding wheel to be used may include a conventional grinding wheel, for example, a diamond resin (SDC) grinding wheel and a diamond resin (SD) grinding wheel. The size of abrasive grains (or the gauge number of the grinding wheel) is, for example, #170 to #2000, preferably #200 to #1800, and further preferably #325 to #1500. In a case where the grain size is excessively small, the productivity may be lowered. In contrast, the grain size is excessively large, it may be difficult to adjust the opening diameter of the outlet.

The camera to be used may include a digital camera such as a CCD camera or a CMOS camera, a laser camera, a thermal imaging camera, and a stereo vision camera. Among them, in light of a high precision of image processing or others, the CCD camera is preferred.

A method of checking the hole on the ground surface and the opening diameter of the hole is not particularly limited to a specific one and may be a method of visually observing an image displayed on a monitor, or data read by image processing may be analyzed by an information analysis apparatus (such as a personal computer) so that the opening diameter can be adjusted to a predetermined diameter in association with a grinding speed.

The precision nozzle obtained through the grinding step may be a nozzle for discharging a variety of fluids, for example, a heated fluid or a non-heated fluid. Further, the heated fluid may be a heat-molten fluid (for example, a solder cream made by injecting a solder ball through an inlet and melting the solder ball inside the hole (the through hole) using a heating means such as laser irradiation).

### EXAMPLES

The following examples are intended to describe this invention in further detail and should by no means be interpreted as defining the scope of the invention.

### Example 1

### [Production of Press Pin]

A cemented carbide was subjected to profile grinding (PG) using an optical profile grinder to produce a pin with a sharp edge having no straight land without limit at the tip. A photomicrograph of the tip of the resulting press pin (a transfer mold) is shown in FIG. 11. The press pin had a tip diameter of 5 μm.

### [Production of Electrode]

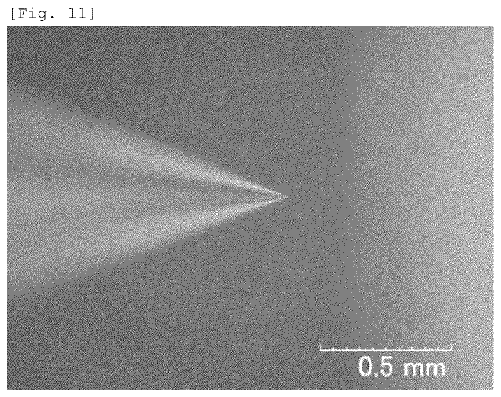

A tungsten W round bar was subjected to profile grinding (PG) using an optical profile grinder to produce a pin (an electrode) with a sharp edge having no straight land without limit at the tip. A photomicrograph of the tip of the resulting electrode and a partial enlarged view thereof are shown in FIG. 12. The electrode had a tip diameter of 4 μm.

### [Compacting Step]

A mixed powder was prepared by mixing 92 g of powdery tungsten carbide WC (average particle size: about 2.5 μm), 8 g of powdery cobalt Co, and 0.8 g of paraffin. A necessary amount of the mixed powder was filled in a mold shown in FIG. 8 formed by a die and a lower punch and was pressed at 150 MPa by an upper punch having the press pin attached thereto to give a cylindrical green compact having a hole (a blind hole).

### [Sintering Step]

The resulting green compact was sintered under vacuum at 1400° C. for 5 hours to give a sintered compact.

### [Electrical Discharge Machining Step]

The sintered compact was subjected to die-sinking electrical discharge machining multiple times, divided into rough machining, semi-finishing, and finishing, using a die-sinking electrical discharge machine (AQ35L manufactured by Sodick Co., Ltd.) and electrodes each having a sharp edge without limit.

### [Grinding Step]

In a grinding step, a grinding machine provided with a disk grinding wheel (“TECSTAR 52” manufactured by AMADA MACHINERY CO., LTD.) was used to process the electrical-discharge-machined sintered compact while checking an image of a ground surface using a CCD camera. If the results of the image check show that the ground surface has no hole, the grinding and the subsequent image check of the ground surface were repeated until a hole was observed on the ground surface. FIG. 13 is a photomicrograph of a tip of a precision nozzle having an outlet which was firstly observed after the hole passed through. The outlet had an opening diameter φ of 5 μm. The minute circular white opening observed in the center of the photomicrograph is the outlet having an opening diameter of 5 μm. The obtained precision nozzle had a tapered hole portion with a depth L of 4240 μm, and the depth of the tapered hole portion relative to the opening diameter φ of the outlet (aspect ratio L/φ) was 848. The tapered hole portion had a slope angle θ of 10°.

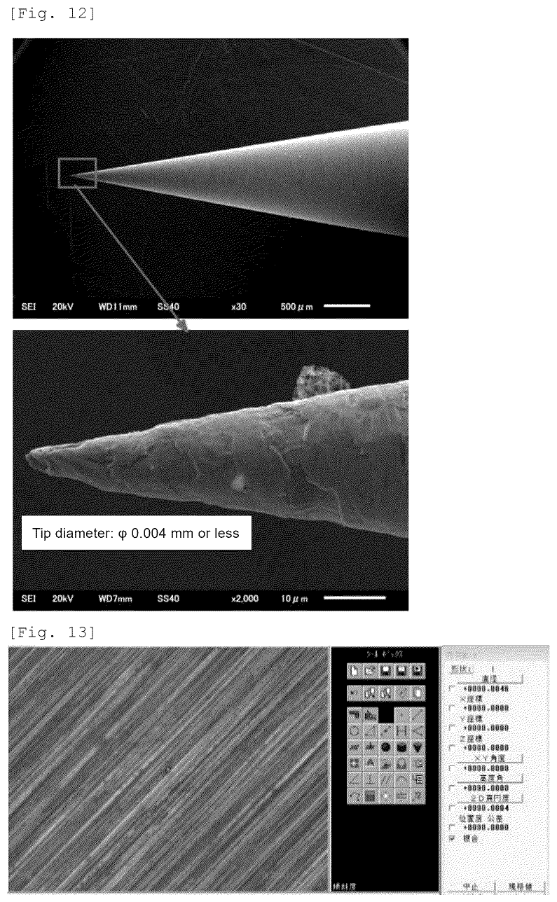

The grinding was further repeated to produce a precision nozzle having an objective outlet. FIG. 14 is a cross-sectional photomicrograph of a tip of the obtained precision nozzle. The hole portion of the nozzle was tapered toward the outlet, and the outlet had an opening diameter φ of 20 μm. The inner wall surface of the tapered hole portion had an arithmetic average roughness Ra of 128 μm, and the tip surface had an arithmetic average roughness Ra of 20 μm.

### Example 2

In the same manner as in Example 1 expect that the time and frequency to check the image of the ground surface were changed in the grinding step, an electrical-discharge-machined sintered compact was produced and ground to finally produce a precision nozzle having an outlet with an opening diameter φ of 39.1 μm. At each check time, the opening diameter of the outlet and the depth of the tapered hole portion were measured to calculate an aspect ratio, and a roundness of the outlet was determined. The results are shown in Table 1. The ground surface checked at the first time and that at the final time were also evaluated for a concentricity of the tip of the precision nozzle (a concentricity of the outline shape of the precision nozzle at the outlet and the outlet).

TABLE 1

| | Opening | | Aspect | | |
|---|---|---|---|---|---|
| Check | diameter | Depth L | ratio | Roundness | Concentricity |
| time | φ (μm) | (μm) | L/φ | (μm) | (μm) |
| First | 12.9 | 4217 | 327 | 3.5 | 11 |
| Second | 20.9 | 4194 | 201 | 3.2 | — |
| Third | 31.1 | 4165 | 134 | 1.3 | — |
| Fourth | 35.0 | 4154 | 119 | 1.5 | — |
| Fifth | 37.6 | 4147 | 110 | 1.6 | — |
| Final | 39.1 | 4143 | 106 | 1.7 | 3 |

As apparent from the results of Table 1, Example 2 made it possible for the precision nozzle having a tapered hole portion with a large aspect ratio to form an outlet with a minute opening diameter and a small roundness. FIG. 15 is a photomicrograph of the cross section of the tip of the precision nozzle at the second check time. The formation of the outlet having a circular shape is observed in the center of the photomicrograph.

### Example 3

In the same manner as in Example 1 expect that the time and frequency to check the image of the ground surface were changed in the grinding step, an electrical-discharge-machined sintered compact was produced and ground to finally produce a precision nozzle having an outlet with an opening diameter φ of 39.5 μm. At each check time, the opening diameter of the outlet and the depth of the tapered hole portion were measured to calculate an aspect ratio, and a roundness of the outlet was determined. The results are shown in Table 2.

TABLE 2

| | Opening | | Aspect | |
|---|---|---|---|---|
| Check | diameter | Depth L | ratio | Roundness |
| time | φ (μm) | (μm) | L/φ | (μm) |
| First | 13.1 | 4216 | 322 | 3.7 |
| Second | 21.7 | 4192 | 193 | 1.4 |
| Final | 39.5 | 4141 | 105 | 1.3 |

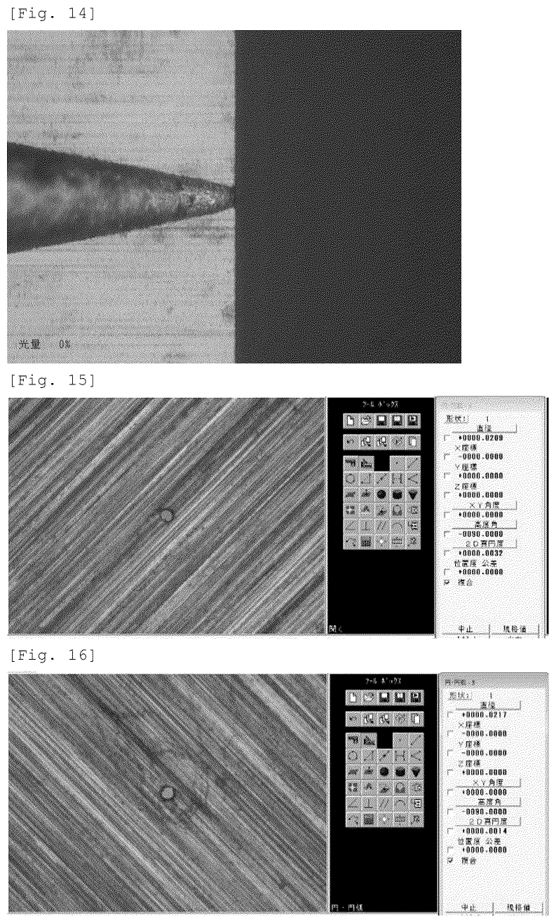

As apparent from the results of Table 2, Example 3 made it possible for the precision nozzle having a tapered hole portion with a large aspect ratio to form an outlet with a minute opening diameter and a small roundness. FIG. 16 is a photomicrograph of the cross section of the tip of the precision nozzle at the second check time. The formation of the outlet having a circular shape is observed in the center of the photomicrograph.

### Example 4

In the same manner as in Example 1 expect that the time and frequency to check the image of the ground surface were changed in the grinding step, an electrical-discharge-machined sintered compact was produced and ground to finally produce a precision nozzle having an outlet with an opening diameter φ of 39.3 μm. At each check time, the opening diameter of the outlet and the depth of the tapered hole portion were measured to calculate an aspect ratio, and a roundness of the outlet was determined. The results are shown in Table 3. The ground surface checked at the final time was also evaluated for a concentricity of the tip of the precision nozzle.

TABLE 3

| | Opening | | Aspect | | |
|---|---|---|---|---|---|
| Check | diameter | Depth L | ratio | Roundness | Concentricity |
| time | φ (μm) | (μm) | L/φ | (μm) | (μm) |
| First | 21.3 | 4193 | 197 | 3.7 | — |
| Second | 34.1 | 4157 | 122 | 1.8 | — |
| Final | 39.3 | 4142 | 105 | 1.5 | 4 |

As apparent from the results of Table 3, Example 4 made it possible for the precision nozzle having a tapered hole portion with a large aspect ratio to form an outlet with a minute opening diameter and a small roundness. FIG. 17 is a photomicrograph of the cross section of the tip of the precision nozzle at the final check time. The formation of the outlet having a circular shape is observed in the center of the photomicrograph.

### Example 5

In the same manner as in Example 1 expect that the time and frequency to check the image of the ground surface were changed in the grinding step, an electrical-discharge-machined sintered compact was produced and ground to finally produce a precision nozzle having an outlet with an opening diameter @ of 39.2 μm. At each check time, the opening diameter of the outlet and the depth of the tapered hole portion were measured to calculate an aspect ratio, and a roundness of the outlet was determined. The results are shown in Table 4. The ground surface checked at the final time was also evaluated for a concentricity of the tip of the precision nozzle.

TABLE 4

| | Opening | | Aspect | | |
|---|---|---|---|---|---|
| Check | diameter | Depth L | ratio | Roundness | Concentricity |
| time | φ (μm) | (μm) | L/φ | (μm) | (μm) |
| First | 21.2 | 4193 | 198 | 3.7 | — |
| Second | 33.7 | 4158 | 123 | 3.0 | — |
| Third | 38.1 | 4145 | 109 | 3.1 | — |
| Final | 39.2 | 4142 | 106 | 3.3 | 2 |

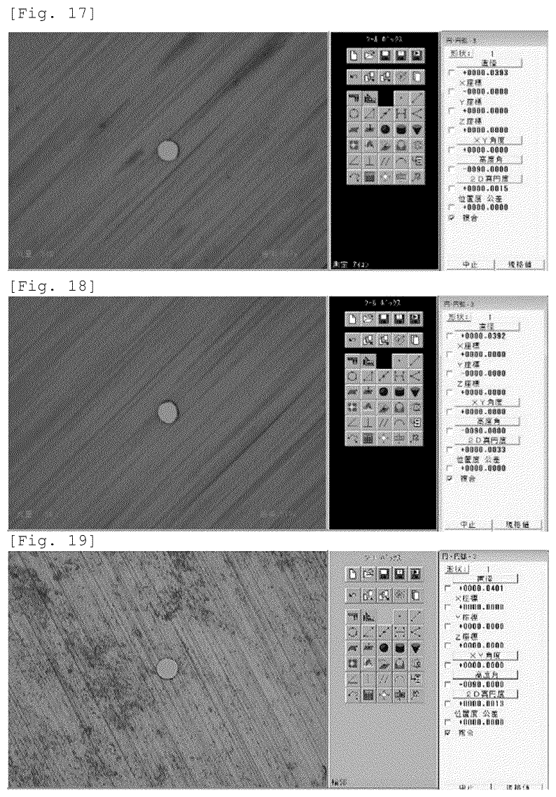

As apparent from the results of Table 4, Example 5 made it possible for the precision nozzle having a tapered hole portion with a large aspect ratio to form an outlet with a minute opening diameter and a small roundness. FIG. 18 is a photomicrograph of the cross section of the tip of the precision nozzle at the final check time. The formation of the outlet having a circular shape is observed in the center of the photomicrograph.

### Example 6

An electrical-discharge-machined sintered compact was produced in the same manner as in Example 1 except that finishing was additionally carried out multiple times in the electrical discharge machining step. In a grinding step, a grinding machine provided with a disk grinding wheel was used to process the electrical-discharge-machined sintered compact while checking an image of a ground surface using a CCD camera. At each check time, the opening diameter of the outlet and the depth of the tapered hole portion were measured to calculate an aspect ratio, and a roundness of the outlet was determined. The results are shown in Table 5. The ground surface checked at the first time and that at the final time were also evaluated for a concentricity of the tip of the precision nozzle.

TABLE 5

| | Opening | | Aspect | | |
|---|---|---|---|---|---|
| Check | diameter | Depth L | ratio | Roundness | Concentricity |
| time | φ (μm) | (μm) | L/φ | (μm) | (μm) |
| First | 37.5 | 4147 | 111 | 0.7 | 2 |
| Second | 38.5 | 4144 | 108 | 0.8 | — |
| Final | 40.1 | 4140 | 103 | 1.3 | 2 |

As apparent from the results of Table 5, Example 6 made it possible for the precision nozzle having a tapered hole portion with a large aspect ratio to form an outlet with a minute opening diameter and a small roundness. FIG. 19 is a photomicrograph of the cross section of the tip of the precision nozzle at the final check time. The formation of the outlet having a circular shape is observed in the center of the photomicrograph.

### Example 7

In the same manner as in Example 6 expect that the time to check the image of the ground surface was changed in the grinding step, an electrical-discharge-machined sintered compact was produced and ground to produce a precision nozzle having an outlet with an opening diameter φ of 42.5 μm. The resulting precision nozzle had a tapered hole portion with a depth L of 4133 μm, and the depth of the tapered hole portion relative to the opening diameter φ of the outlet (aspect ratio L/φ) was 97. The outlet had a roundness of 0.8 μm, and the tip of the precision nozzle had a concentricity of 3 μm.

### Example 8

In the same manner as in Example 6 expect that the time and frequency to check the image of the ground surface were changed in the grinding step, an electrical-discharge-machined sintered compact was produced and ground to finally produce a precision nozzle having an outlet with an opening diameter φ of 39.9 μm. At each check time, the opening diameter of the outlet and the depth of the tapered hole portion were measured to calculate an aspect ratio, and a roundness of the outlet and a concentricity of the tip of the precision nozzle were determined. The results are shown in Table 6.

TABLE 6

| | Opening | | Aspect | | |
|---|---|---|---|---|---|
| Check | diameter | Depth L | ratio | Roundness | Concentricity |
| time | φ (μm) | (μm) | L/φ | (μm) | (μm) |
| First | 37.9 | 4146 | 109 | 0.9 | 4 |
| Final | 39.9 | 4140 | 104 | 0.8 | 6 |

As apparent from the results of Table 6, Example 8 made it possible for the precision nozzle having a tapered hole portion with a large aspect ratio to form an outlet with a minute opening diameter and a small roundness, FIG. 20 is a photomicrograph of the cross section of the tip of the precision nozzle at the final check time. The formation of the outlet having a circular shape is observed in the center of the photomicrograph.

### Example 9

An electrical-discharge-machined sintered compact was produced in the same manner as in Example 1 except that finer powdery tungsten carbide WC (average particle size: about 0.8 μm) was used as powdery tungsten carbide WC in the compacting step. In a grinding step, a grinding machine provided with a disk grinding wheel was used to process the electrical-discharge-machined sintered compact while checking an image of a ground surface using a CCD Camera. At each check time, the opening diameter φ of the outlet and the depth L of the tapered hole portion were measured to calculate an aspect ratio. The results are shown in Table 7. The ground surface checked at the first time was also evaluated for a concentricity of the tip of the precision nozzle, the ground surface checked at the fifth time was also evaluated for a roundness of the outlet, and the ground surface checked at the first time and that at the final time were also evaluated for a roundness of the outlet and a concentricity of the tip of the precision nozzle.

TABLE 7

| | Opening | | Aspect | | |
|---|---|---|---|---|---|
| Check | diameter | Depth L | ratio | Roundness | Concentricity |
| time | φ (μm) | (μm) | L/φ | (μm) | (μm) |
| First | 22.0 | 4191 | 191 | — | 8 |
| Second | 28.0 | 4174 | 149 | — | — |
| Third | 30.0 | 4168 | 139 | — | — |
| Fourth | 36.7 | 4149 | 113 | — | — |
| Fifth | 38.5 | 4144 | 108 | 2.5 | — |
| Final | 39.5 | 4141 | 105 | 2.1 | 3 |

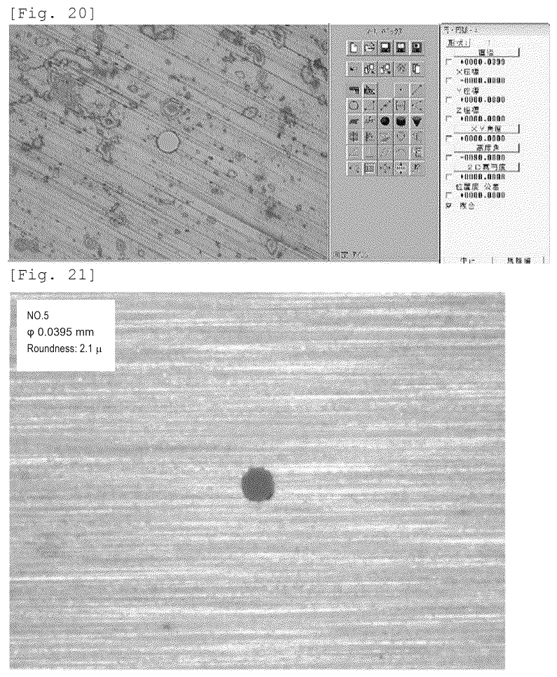

As apparent from the results of Table 7, Example 9 made it possible for the precision nozzle having a tapered hole portion with a large aspect ratio to form an outlet with a minute opening diameter and a small roundness. FIG. 21 is a photomicrograph of the cross section of the tip of the precision nozzle at the final check time. The formation of the outlet having a circular shape is observed in the center of the photomicrograph.

### Example 10

A precision nozzle having an outlet with an opening diameter φ of 5 μm (a roundness of 0.4 μm) was obtained in the same manner as in Example 1 except that finishing was additionally carried out multiple times in the electrical discharge machining step.

### INDUSTRIAL APPLICABILITY

The precision nozzle of the present invention can be used as various precision nozzles with a minute outlet, for example, can suitably be used as a nozzle for an electronic component; such a nozzle is used for assembly of a micro component or mounting thereof on a substrate in a production process of a conductor device. Examples of the nozzle for an electronic component may include a reflow nozzle, a suction nozzle, and a solder jetting nozzle. In particular, the precision nozzle is suitably used as a reflow nozzle for discharging a molten solder ball.

### REFERENCE SIGNS LIST

1 . . . Nozzle
2 . . . Inlet
3 . . . Through hole
3a . . . Cylindrical hole portion
3b . . . Tapered hole portion
4 . . . Outlet

1. A process for producing a precision nozzle, the precision nozzle comprising a cemented carbide and having a through hole passing through from an inlet to an outlet, the through hole at least containing a tapered hole portion, and the tapered hole portion extending to increase in inner diameter from the outlet as a starting point toward the inlet, the process comprising:
a compacting step of compression-forming a raw powder using a transfer mold for forming the through hole to give a compact that has a blind hole with an opening corresponding to the inlet,
a sintering step of sintering the compact to give a sintered compact of the compact,
an electrical discharge machining step of subjecting the sintered compact to electrical discharge machining using an electrode inserted to the blind hole of the sintered compact, and
a grinding step of grinding the electrical-discharge-machined sintered compact from a side opposite to the opening, which corresponds to the inlet, to form the outlet.

2. The production process according to claim 1, wherein the through hole has a circular, oval, or polygonal cross-sectional shape.

3. The production process according to claim 2, wherein the through hole has a circular cross-sectional shape.

4. The production process according to claim 1, wherein, in the compacting step, the transfer mold has a shape corresponding to a shape of the through hole, the transfer mold contains a tapered portion corresponding in shape to the tapered hole portion, and the tapered portion has a conical, ovally conical, or polygonal pyramid shape.

5. The Production process according to claim 4, wherein the tapered portion corresponding in shape to the tapered hole portion has a conical shape.

6. The production process according to claim 5, wherein the transfer mold contains a conical portion corresponding in shape to the tapered hole portion, and the conical portion has a tip diameter of not more than 5 μm.

7. The production process according to claim 1, wherein, in the electrical discharge machining step, the electrode has a shape corresponding to a shape of the transfer mold.

8. The production process according to claim 7, wherein the electrode contains a conical portion corresponding in shape to the tapered hole portion, and the conical portion of the electrode, corresponding in shape to the tapered hole portion, has a tip diameter of not more than 5 μm.

9. The production process according to claim 1, wherein, in the grinding step, a presence of a hole as the outlet is observed and an opening diameter of the hole is determined using image(s) of the ground surface taken with a camera.

10. The production process according to claim 1, wherein the through hole consists of the tapered hole portion and a cylindrical hole portion extending from the tapered hole portion to the inlet.

11. The production process according to claim 1, wherein the outlet has an opening diameter of less than 30 μm.

12. The production process according to claim 1, wherein the precision nozzle is a nozzle for an electronic component.

13. The production process according to claim 1, wherein the precision nozzle is a reflow nozzle for discharging a molten solder ball.

14. A precision nozzle comprising a cemented carbide,
having a through hole passing through from an inlet from an outlet,
the through hole containing a tapered hole portion extending to increase in inner diameter from the outlet toward the inlet,
the outlet having an opening diameter of less than 45 μm, and
the tapered hole portion having a length of not less than 1 mm in a nozzle axial direction.

15. The precision nozzle according to claim 14, wherein the length of the tapered hole portion in the nozzle axial direction is not less than 10 times as long as the opening diameter of the outlet.

16. The precision nozzle according to claim 14, wherein the outlet has a circular shape, and the outlet has a roundness of not more than 5 μm.

17. The precision nozzle according to claim 14, wherein an outline shape of the precision nozzle at the outlet is an isotropic shape, the outlet has a circular shape, and the outline shape and the outlet have a concentricity of not more than 10 μm.

18. The precision nozzle according to claim 14, wherein the tapered hole portion has a slope angle of 3 to 60°.

19. The precision nozzle according to claim 14, wherein the outlet has an opening diameter of less than 30 μm.

20. The precision nozzle according to claim 14, wherein
the outlet has an opening diameter of not less than 1 μm to less than 30 μm,
the tapered hole portion has a length of 1 to 20 mm in the nozzle axial direction,
the length of the tapered hole portion in the nozzle axial direction is not less than 100 times as long as the opening diameter of the outlet,
the outlet has a circular shape, and the outlet has a roundness of not more than 5 μm,
an outline shape of the precision nozzle at the outlet is a circular shape, and the outline shape and the outlet have a concentricity of not more than 10 μm, and
the tapered hole portion has a slope angle of 4 to 50°.

21. The precision nozzle according to claim 14, wherein the cemented carbide is an alloy containing tungsten carbide.
